(19) United States
(12) Patent Application Publication
(10) Pub. No.: US 2010/0253568 A1
(43) Pub. Date: Oct. 7, 2010

(54) METHOD FOR EXCHANGING RADAR SIGNALS

(75) Inventor: Thomas Focke, Ahrbergen (DE)

Correspondence Address: KENYON & KENYON LLP, ONE BROADWAY, NEW YORK, NY, 10004, US

(73) Assignee: ROBERT BOSCH GMBH, Stuttgart (DE)

(21) Appl. No.: 12/740,214

(22) PCT Filed: Sep. 19, 2008
(86) PCT No.: PCT/EP2008/062543

§ 371 Date: Apr. 28, 2010

(30) Foreign Application Priority Data
Nov. 19, 2007 (DE) 102007055185.3

(51) Int. Cl. G01S 13/48

(52) U.S. Cl. 342/118; 342/175

(57) ABSTRACT

A method for exchanging radar signals, in which it is provided that for a system having a number of radar transceiver chips, a detection range for radar signals is set for each chip so that a plurality of detection ranges for radar signals is covered for the entire system simultaneously.

### FIELD OF THE INVENTION

The present invention relates to a method for exchanging radar signals, a system for exchanging radar signals, a computer program, and a computer program product.

### BACKGROUND INFORMATION

At present, many system providers are pressing ahead with the development of so-called stand-alone radar transceiver chips in silicon-germanium semiconductor technology, so that chips of this type will be available for various applications in the near future. One goal of these developments is to provide small and inexpensive system components. Such system components or chips are able to be operated as single-chip radar, for example, or in an array as multi-chip radar. In devices for multi-chip radar, an amplification of an emitted or receivable output by beam formation or radiation formation is able to be achieved by interconnecting, in a defined geometric array, identical chips that have an identical, fixedly coupled transmission behavior.

From the printed publication U.S. 2005/0151215 A1, an antenna array having a chip designed to transmit and receive electromagnetic waves is discussed. Such a chip is mounted directly on a switching circuit of the antenna array, a contact between the chip and the switching circuit being provided via a multitude of interconnected contact elements on the side of the chip and on the side of the switching circuit.

### SUMMARY OF THE INVENTION

The present invention relates to a method for exchanging radar signals. For a system which includes a number of radar transceiver chips, a detection range for radar signals is set for each chip in such a way that a plurality of detection ranges for radar signals is covered for the entire system simultaneously.

In one development, a detection range is switched individually for each chip. Depending on the application, this may also mean that a plurality of chips is switched for the same detection range for amplification purposes. The result is, inter alia, that a plurality of usually different signal shapes for radar signals is able to be processed using the differently set or switched chips.

Depending on the specifications, the chips of the systems may be functionally interconnected. The method may also be carried out during active operation of the system, so that it is possible to adjust the usually different detection ranges for the radar signals at any time in an application-specific manner.

In one development, each radar transceiver chip is able to be adjusted individually, so that each chip exchanges, i.e., receives and/or transmits, radar signals of a specific selected frequency. As a result, the entire system is able to exchange different radar signals on different frequencies. In a further variant of the method it results that frequencies of the radar signals are decoupled.

In addition, the present invention relates to a system for the exchange of radar signals, which system has a number of radar-transceiver chips. In this system, a detection range for radar signals is able to be adjusted for each chip in such a way that a plurality of detection ranges for radar signals is able to be covered for the entire system simultaneously.

This system functionally corresponds to an antenna and is designed to transmit and/or receive radar signals. To receive and/or transmit radar signals for different detection ranges having different signal forms and using different frequencies, the system is able to be set in a modular manner, usually while operating, by modular setting and/or switching of the chips.

By providing the radar transceiver chips, a plurality of radar sensors for different detection ranges for radar signals on different frequencies are combined in a flexible manner in this system.

Moreover, among other things, the system provides a sensor multiplex or a sensor selection switching network for different radar signals, in which, for example, a phase-locked superimposition of a directivity characteristic desired for an application is able to be provided as a detection range to be set.

For example, the present invention enables a flexible interconnection of individual radar transceiver chips or transceiver switching circuits in order to make it possible to set up, in variable manner, a detection range provided from a plurality of detection ranges in modular fashion. As a result, at least one chip of the system provides at least one radar signal on one frequency while providing at least one reception range. This also means that, exploiting synergy effects, groups of individual chips are jointly able to combine a plurality of radar signals on one frequency in order to form an enlarged reception range with an amplified output.

The described system is designed to execute all of the steps of the introduced method. Individual steps of this method are also able to be implemented by individual components of the system. Furthermore, functions of the system, or functions of individual components of the system, may be implemented as steps of the method.

In addition, the invention relates to a computer program having program code means for implementing all of the steps of a described method when the computer program is executed on a computer or a corresponding central processing unit, in particular a system according to the present invention.

The computer program product according to the present invention having program code means, which are stored on a computer-readable data carrier, is designed to execute all of the steps of a described method when the computer program is executed on a computer or a corresponding .processing unit, in particular a system according to the present invention.

Because of the technical fact that the radar transceiver chips are operated using different transmit signal shapes in order to provide the detection ranges, groups of chips are able to be functionally interconnected within the system in a flexible manner during active operation. This produces a scalable functionality of the system, i.e., one that is modifiable in its size, as an overall radar sensor, the functionality being adaptable to the particular traffic situation in one possible application. This may be accomplished on the basis of very inexpensive individual standard components, i.e., chips. In one development of the system, the frequencies for the transmission and/or reception are able to be decoupled during active operation of a sensor multiplex provided as one development of the system within the scope of the present invention; no activation or deactivation via selector switches is required.

In one development of the present invention, a fixed system of radar transceiver chips and thus an array, is provided in a radar sensor housing, and the received signals are evaluated in such a manner that a phase-locked superimposition of the transmit and receive signals produces a desired directivity characteristic of the sensor for radar radiation.

In addition, the radar transceiver chips may have a flexible design as far as their frequencies for the transmission and/or reception as well as their modulation method are concerned, to the effect that a plurality of such chips in a fixed system is able, inter alia, both to emit and/or receive identical signals simultaneously and also to operate in a completely decoupled manner on different frequencies and using different modulation methods. In this way, a single radar sensor is typically able to provide a plurality of radar sensors. This makes it possible to provide different dynamic characteristic quantities for detection ranges, such as distance resolution, velocity resolution or acceleration resolution, for example, in different spatial directions.

In one development of the present invention, individual ramps and/or modulation methods are able to be formed by different center frequencies via subgroups of modules or individual modules, and thus chips, each of which in turn having its own directivity characteristic. If frequencies having a specific, sufficiently large frequency spacing are provided, then the signals of the individual subgroups are able to be separated from each other via filters in a receiving case, and the resulting directivity characteristics are then decoupled from each other. An analogous procedure is also possible when transmitting on different frequencies.

In one case, each module or each chip may operate on its own frequency, so that a number of n individual sensors provided via the chips are present; while each individual sensor by itself has a short range, the visual range is broad. The number of modules or chips that are part of a subgroup is based on the specific function, a traffic state or traffic situation, or a receive signal situation in which a vehicle equipped with the system happens to be in. This usually defines a relevant detection range.

Arbitrary configurations, i.e., including nested configurations, are also able to be generated within the framework of the present invention, which therefore allows the functional interconnection of modules that are not situated adjacent to each other. Accordingly, at least two chips, between which at least one additional chip is situated within the system, which chip sets these at least two chips apart from one another, are able to be functionally interconnected. Therefore, the system allows such a functional interconnection of chips independently of the position. Furthermore, the chips may be synchronized and ambiguity effects corrected by suitable signal processing of radar signals that are received and/or transmitted.

Numerous functions in the vehicle's environment sensor system based on radar technology usually require the coverage of different detection ranges both with regard to dynamic variables such as distance and/or velocity, and with regard to an angle. At the same time, however, the development of different special radar sensors constitutes a considerable cost factor.

In one application, the present invention allows the flexible and cost-effective interconnection of fixedly placed standard radar transceiver chips, which may be germanium-silicon semiconductors, in order to realize different directivity characteristics and beam multiplex constellations so as to provide detection ranges.

Furthermore, a flexible sensor multiplex is provided to perform spectral measurements with an associated field of view as detection range. The present invention may be used in a radar sensor system for detecting the vehicle environment, for example.

Additional advantages and refinements of the present invention are yielded from the description and the accompanying drawing.

It is understood that the features mentioned above and the features yet to be described below may be used not only in the combination given in each case but also in other combinations or individually, without departing from the scope of the present invention.

### BRIEF DESCRIPTION OF THE DRAWINGS

FIG. 1 shows a schematic illustration of a first development of a system of a plurality of radar transceiver chips together with an associated transmit-signal scheme, in a first operating mode.

FIG. 2 shows a schematic illustration of an exemplary directivity pattern for the first operating mode according to FIG. 1.

FIG. 3 shows a schematic illustration of a second development of a system of a plurality of radar transceiver chips together with an associated transmit-signal scheme, in a second operating mode.

FIG. 4 shows a schematic illustration of an exemplary directivity pattern for the second operating mode according to FIG. 3.

### DETAILED DESCRIPTION

The present invention is represented schematically in the drawing with the aid of specific embodiments, and is described in detail below with reference to the drawings.

The figures are described in a cohesive and comprehensive manner; matching reference numerals denote identical components.

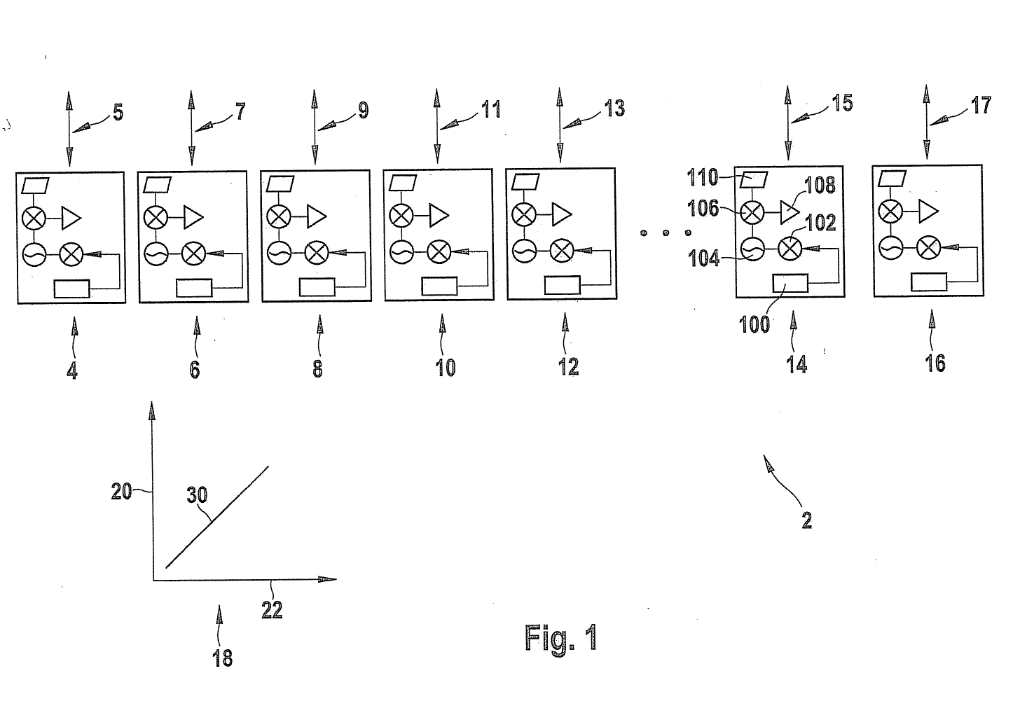

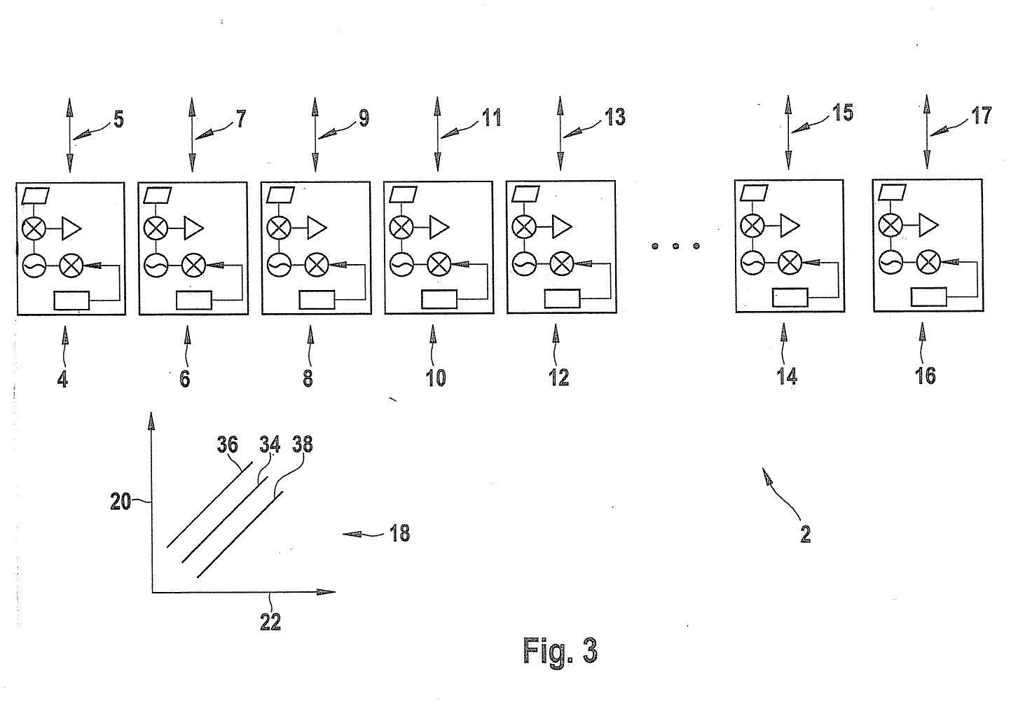

FIGS. 1 and 3 show a system 2, which includes a number of radar transceiver chips 4, 6, 8, 10, 12, 14, 16 interconnected in the form of an array or a field; only seven of these radar transceiver chips 4, 6, 8, 10, 12, 14, 16 are shown in each instance.

A first chip 4 is designed to exchange a first radar signal 5, a second chip 6 is designed to exchange a second radar signal 7, a third chip 8 is designed to exchange a third radar signal 9, a fourth chip 10 is designed to exchange a fourth radar signal 11, a fifth chip 12 is designed to exchange a fifth radar signal 13, a sixth chip 14 is designed to exchange a sixth radar signal 15, and a seventh chip 16 is designed to exchange a seventh radar signal 17. Such an exchange of a radar signal 5, 7, 9, 11, 13, 15, 17 by an individual chip 4, 6, 8, 10, 12, 14, 16 includes the possibility that an individual radar signal 5, 7, 9, 11, 13, 15, 17 is able to be received as well as transmitted on one frequency.

Furthermore, using sixth chip 14, the components of all chips 4, 6, 8, 10, 12, 14, 16, which have an identical structure, will be described. They include a phase-controlled closed-loop control circuit 100 (PLL), which in this case is interconnected to a switching circuit which includes a first mixer 102, an HF signal source 104 for providing a high-frequency signal, a second mixer 106, a driver 108, as well as an antenna module 110 for the transmission and reception of radar signals 5, 7, 9, 11, 13, 15, 17.

In addition, FIGS. 1 and 3 each show a modulation diagram 18, in which a frequency axis 20 has been plotted above a time axis 22.

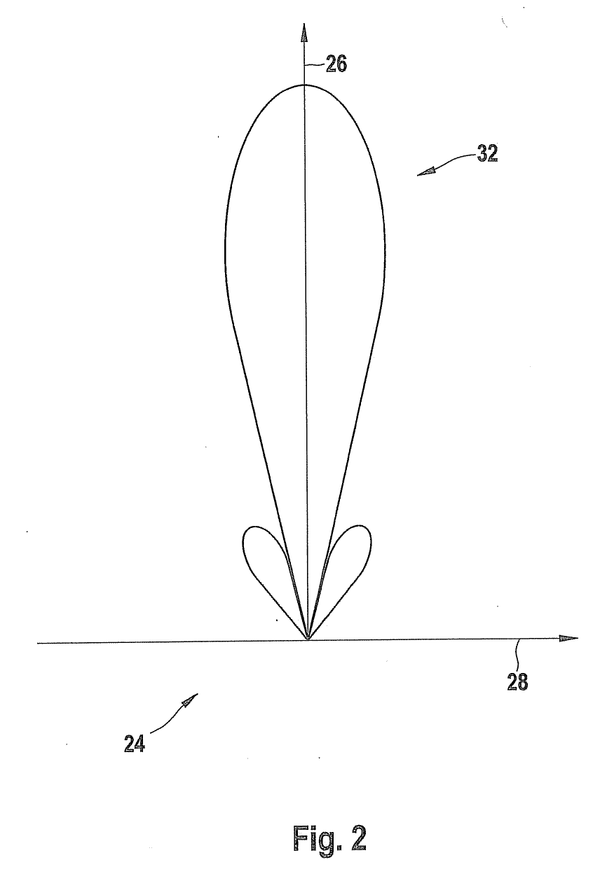

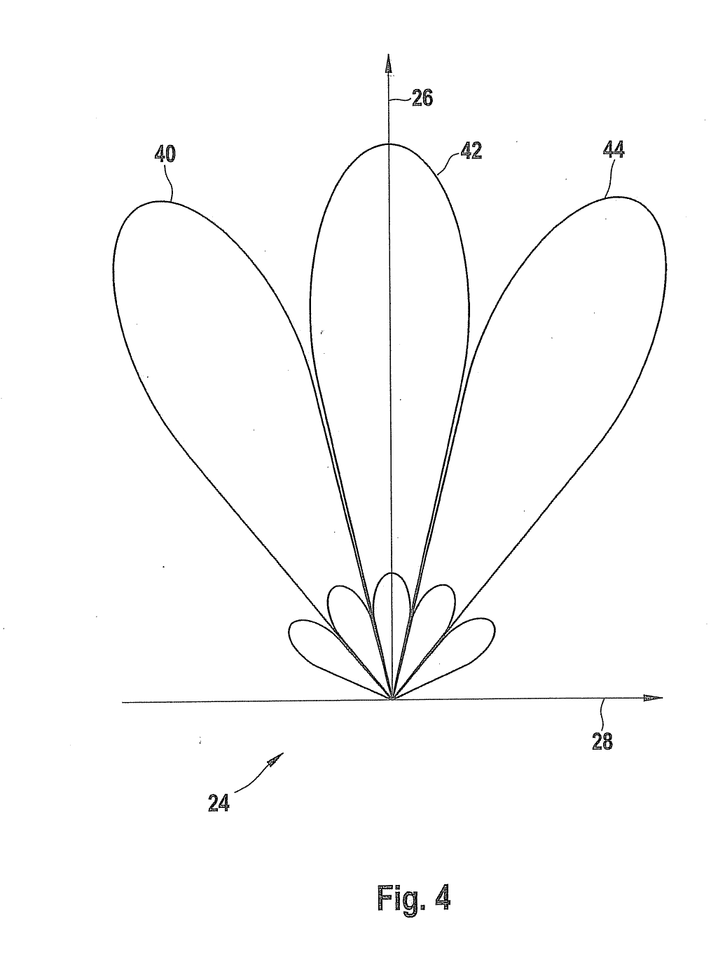

In the two directivity diagrams 24 of FIGS. 2 and 4, which are provided in order to illustrate detection ranges of the operating modes described with the aid of FIGS. 1 and 3, a vertically aligned axis 26 for an output P has been plotted above a horizontally aligned axis 28 for an angle Φ.

FIG. 1 shows in a schematic illustration a generic set-up of a plurality of radar transceiver chips 4, 6, 8, 10, 12, 14, 16 of system 2, all chips 4, 6, 8, 10, 12, 14, 16 transmitting and receiving radar signals 5, 7, 9, 11, 13, 15, 17 simultaneously on the same frequency in a first operating mode, in other words, they are coupled to one another in a phase-locked manner. The result is a relatively narrow directivity diagram with a high antenna output, in which a frequency ramp 30 for a common frequency of all radar signals 5, 7, 9, 11, 13, 15, 17 is run through as illustrated by modulation diagram 18 of FIG. 1. System 2 is operated for an FMCW modulation method and thus for a modulation method for a frequency-modulated continuous wave radar.

Directivity diagram 24 from FIG. 2 shows a first detection range 32 for a frequency 30 for the first operating mode of system 2.

FIG. 3 provides a schematic illustration of system 2 made up of radar transceiver chips 4, 6, 8, 10, 12, 14, 16 in a second specific development while implementing a second operating mode. The first three chips 4, 6, 8 exchange, and thus receive and transmit, their radar signals 5, 7, 9 on a first frequency. In this context, a first frequency ramp 34 for this first frequency is plotted in modulation diagram 18 from FIG. 3. Fourth and fifth chips 10, 12 exchange their radar signals 11, 13 on a second frequency, a second frequency ramp 36 for this second frequency likewise being plotted in diagram 18. In addition, sixth and the seventh chips 14, 16 exchange radar signals 15, 17 on a third frequency, a third frequency ramp 38 for this third frequency likewise being shown in diagram 18.

Directivity diagram 24 from FIG. 4 shows detection ranges 40, 42, 44 resulting in the second operating mode of system 2. On the left, a first detection range 40 for first three radar signals 5, 7, 9 exchanged on the first frequency has been plotted. A second detection range 42 in the center of directivity diagram 24 is provided by the exchange of fourth and fifth radar signals 11, 13 on the second frequency.

Sixth and seventh radar signals 15, 17 are exchanged on the third frequency. In this context, directivity diagram 24 from FIG. 4 shows a resulting third detection range 44 on the right.

1-11. (canceled)

12. A method for exchanging radar signals, the method comprising:
setting, for a system having a number of radar transceiver chips, a detection range for radar signals for each chip so that a plurality of detection ranges for radar signals is covered simultaneously for the entire system.

13. The method of claim 12, wherein a detection range is switched for each chip.

14. The method of claim 12, wherein a plurality of signal shapes for radar signals is processed.

15. The method of claim 12, wherein the chips are functionally interconnected.

16. The method of claim 12, wherein the detection ranges are set during an active operation of the system.

17. The method of claim 12, wherein frequencies of the radar signals are decoupled.

18. A system for exchanging radar signals, comprising:
a number of radar transceiver chips;
a detection range for radar signals is adjustable for each chip so that a plurality of detection ranges for radar signals is able to be covered for the entire system simultaneously.

19. The system of claim 18, wherein the system is configured for transmitting radar signals.

20. A computer readable medium having a computer program, which is executable by a computer, comprising:
a program code arrangement having program code for exchanging radar signals, by performing the following:
setting, for a system having a number of radar transceiver chips, a detection range for radar signals for each chip so that a plurality of detection ranges for radar signals is covered simultaneously for the entire system.

21. The computer readable medium of claim 20, wherein a detection range is switched for each chip.

22. The computer readable medium of claim 20, wherein a plurality of signal shapes for radar signals is processed.

23. The computer readable medium of claim 20, wherein the chips are functionally interconnected.

24. The computer readable medium of claim 20, wherein the detection ranges are set during an active operation of the system.

25. The computer readable medium of claim 20, wherein frequencies of the radar signals are decoupled.
